(19) United States
(12) Patent Application Publication
(10) Pub. No.: US 2008/0042549 A1
(43) Pub. Date: Feb. 21, 2008

(54) ORGANIC LIGHT EMITTING DIODE DISPLAY AND METHOD OF MANUFACTURING THE SAME

(75) Inventors: Young-Rok SONG, Yongin-si (KR); Kyong-Tae PARK, Uijeongbu-si (KR); Beohm-Rock CHOI, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/765,230

(22) Filed: Jun. 19, 2007

(30) Foreign Application Priority Data
Aug. 18, 2006 (KR) 10-2006-0078157

(51) Int. Cl. H01J 1/62; H01J 9/24

(52) U.S. Cl. 313/498; 445/24

(57) ABSTRACT

An organic light emitting diode (“OLED”) display and a manufacturing method thereof according to the present invention includes: a display panel including a display area in which a plurality of thin film transistors and an emission layer are formed and a peripheral area disposed along a circumference of the display area; at least one driver provided in the peripheral area, the driver applies a display signal including a gate signal and a data signal to each thin film transistor; a voltage pad formed in the peripheral area, the voltage pad which applies at least one of a driving voltage and a common voltage to the display area; an exterior voltage source input section which applies at least one of the driving voltage and the common voltage to the voltage pad; a metal wire connecting the exterior voltage source input section and the voltage pad; and a conductive fixing member for fixing the metal wire to the voltage pad.

This application claims priority to Korean Patent Application No. 10-2006-0078157, filed on Aug. 18, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to an organic light emitting diode (“OLED”) display and method of manufacturing the same.

(b) Description of the Related Art

Recently, an OLED display among flat panel displays is being spotlighted due to advantages which include low driving voltage, slimness and light weight, wide viewing angle and high-speed response.

An OLED display includes a display panel which forms an image and a driver for driving the display panel.

Switching thin film transistors (“TFTs”) are formed at intersections of gate lines and data lines to form pixels and driving TFTs are connected to driving voltage lines for applying a driving voltage in the display panel. Also, voltage pads for supplying a common voltage applied to a common electrode and a driving voltage applied to driving voltage lines are respectively formed at an edge of the display panel.

As an OLED display increases in size and the number of pixels thereof correspondingly increases for higher resolution, a sufficient amount of a common voltage, as well as a driving voltage, should be supplied. At present, the common voltage or the driving voltage is supplied from an edge of the display panel using a printed circuit board (“PCB”) and a flexible printed circuit (“FPC”) provided separately from a driver to improve power supply stability and to improve uniformity of the entire substrate.

However, using a plurality of PCBs causes an increase in a thickness of an OLED display. In addition, installation of the plurality of PCBs makes a modulation process difficult due to the manufacturing cost and complicated structure of the PCBs.

### BRIEF SUMMARY OF THE INVENTION

The present invention has been made in an effort to provide an OLED display having a simple thin structure and having the advantage of easy modulation and a simple method of manufacturing there same.

An exemplary embodiment of the present invention provides an organic light emitting diode display comprising: a display panel including a display area in which a plurality of thin film transistors and an emission layer are formed and a peripheral area disposed along a circumference of the display area; at least one driver provided in the peripheral area, the driver applies a display signal including a gate signal and a data signal to the thin film transistor; a voltage pad formed in the peripheral area, the voltage pad applies at least one of a driving voltage and a common voltage to the display area; an exterior voltage source input section applies at least one of the driving voltage and the common voltage to the voltage pad; a metal wire connecting the exterior voltage source input section and the voltage pad; and a conductive fixing member for fixing the metal wire to the voltage pad.

Here, a diameter of the metal wire may be about 0.05 millimeters (mm) to about 0.5 millimeters (mm).

The organic light emitting diode display may further comprise an insulating coat covering the metal wire, wherein the insulating coat is removed from a fixed part of the metal wire corresponding to the conductive fixing member.

The conductive fixing member may include lead formed by soldering or a hardened conductive resin.

The organic light emitting diode display may further comprise: an anisotropic conductive film formed on the voltage pad; and a flexible conductive film formed on the anisotropic conductive film and wrapped around the metal wire and the conductive fixing member.

The organic light emitting diode display may further comprise an insulating resin formed along the peripheral area and covering the conductive fixing member and the metal wire.

The organic light emitting diode display may further comprise an encapsulating member covering the display area of the display panel.

The metal wire may be formed along a lateral side of the encapsulating member.

The driver may comprise: a circuit board which generates the display signal; a soft member connecting the display panel and the circuit board; and a data driver which applies a data signal received from the circuit board to the thin film transistor.

The driver may further comprise at least one gate driver which applies a gate signal to the thin film transistor.

The exterior voltage source input section may be connected to the circuit board.

The voltage pad may be at least one of a driving voltage pad and a common voltage pad formed in an opposite peripheral area of a peripheral area in which the gate driver or the data driver is formed with the display area interposed therebetween.

The gate driver or the data driver may be plural in number, and the voltage pad may be at least one of a driving voltage pad and a common voltage pad formed between a plurality of the gate drivers or the data drivers.

Another exemplary embodiment of the present invention provides a method of manufacturing method an organic light emitting diode display, the method comprising: providing a display panel including a display area in which a thin film transistor and an emission layer are formed and a peripheral area in which a voltage pad, which applies at least one of a driving voltage and a common voltage to the display area, is formed, the peripheral area being formed along a circumference of the display area; disposing a metal wire in the peripheral area, one end of the metal wire is connected to an exterior voltage source input section; fixing the metal wire on the voltage pad using a conductive fixing member; and forming an insulating resin covering the conductive fixing member and the metal wire along the peripheral area.

Here, the method may further comprise forming an encapsulating member covering the display area on the display panel after the providing of the display panel and before the disposing of the metal wire in the peripheral area.

The method may further comprise attaching a portion of a flexible conductive film on the voltage pad using an anisotropic conductive film after the providing of the display panel and before the disposing of the metal wire in the peripheral area.

The method may further comprise wrapping the metal wire and the conductive fixing member by curving the flexible conductive film after the fixing of the metal wire on the voltage pad using the conductive fixing member.

The conductive fixing member may include lead, and the fixing of the metal wire on the voltage pad may be performed by soldering of the lead.

The conductive fixing member may include a hardened conductive resin, and the fixing of the metal wire on the voltage pad may comprise: coating a conductive resin composition in a liquid or gel state including a hardener on the metal wire disposed on the voltage pad; and hardening the conductive resin composition.

The providing of the display panel may further comprise forming at least one driver in the peripheral area, the driver applies a display signal which includes a gate signal and a data signal to the thin film transistor.

### BRIEF DESCRIPTION OF THE DRAWINGS

The present invention will become more apparent by describing exemplary embodiments thereof in detail with reference to the accompanying drawings, in which:

FIG. 1 is an exploded perspective view of an exemplary embodiment of an OLED display according to the present invention;

FIG. 2 is an equivalent circuit schematic diagram of an exemplary embodiment of an OLED display according to the present invention;

FIG. 3 is a top plan view of an exemplary embodiment of a display panel of an OLED display according to the present invention;

FIG. 4 is a cross-sectional view of the display panel of the OLED display shown in FIG. 3 taken along line IV-IV;

FIGS. 5A, 6A, 7A and 8A are respective top plan views of the display panel illustrating intermediate processing of an exemplary embodiment of a method of manufacturing the OLED display shown in FIG. 1 according to the present invention;

FIGS. 5B, 6B, 7B and 8B are cross-sectional views of the display panel of the OLED display shown in FIGS. 5A, 6A, 7A and 8A taken along lines Vb-Vb, VIb-VIb, VIIb-VIIb and VIIIb-VIIIb, respectively;

FIG. 9 is a top plan view of another exemplary embodiment of a display panel of an OLED display according to the present invention;

FIG. 10 is a cross-sectional view of the display panel of the OLED display shown in FIG. 9 taken along line X-X;

FIG. 11 is a top plan view of yet another exemplary embodiment of a display panel of an OLED display according to the present invention; and

FIG. 12 is a top plan view of still another exemplary embodiment of a display panel of an OLED display according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in more detail with reference to the accompanying drawings.

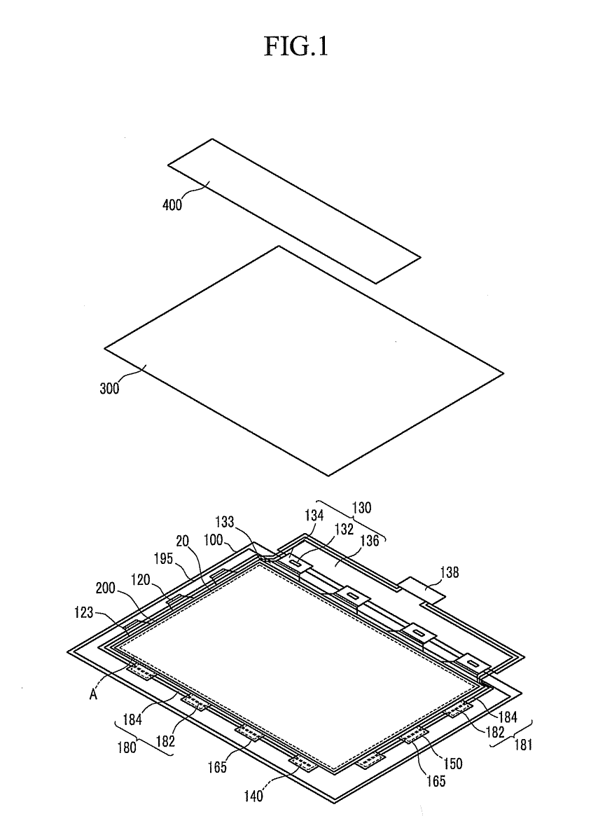

First, an exemplary embodiment of an OLED display according to the present invention will be described in more detail with reference to FIGS. 1-4.

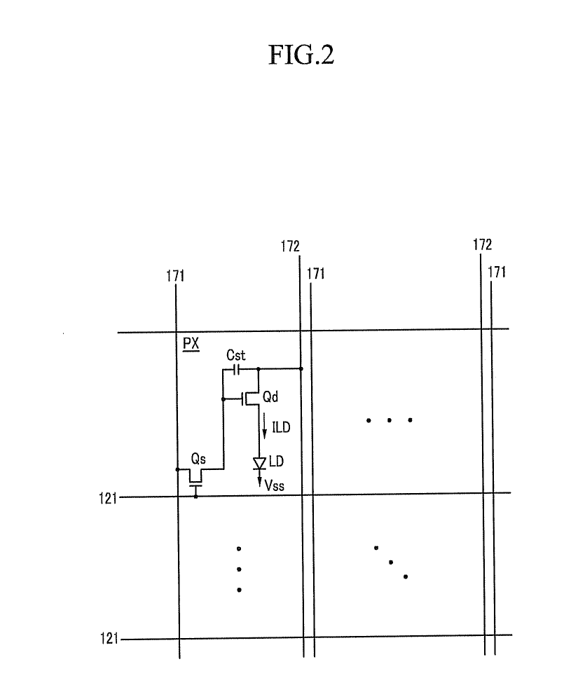

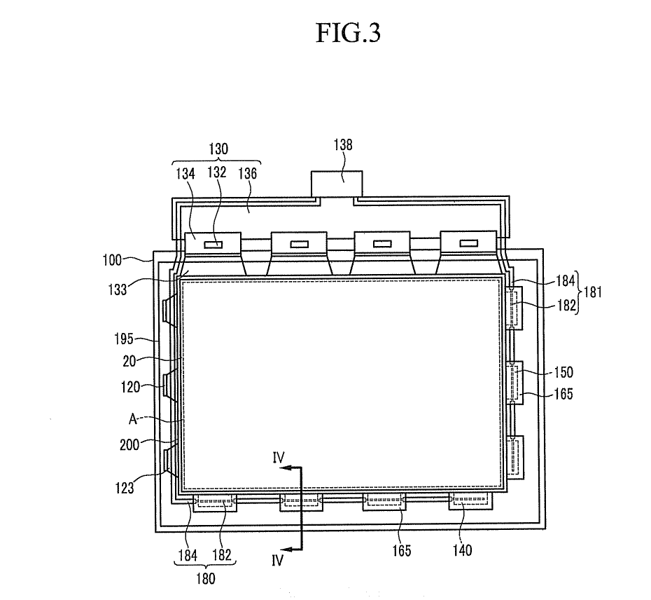

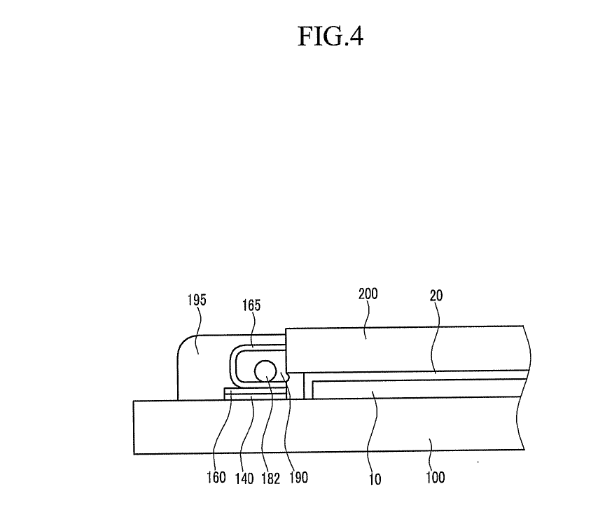

FIG. 1 is an exploded perspective view of an exemplary embodiment of an OLED display according to the present invention. FIG. 2 is an equivalent circuit schematic diagram of an exemplary embodiment of an OLED display according to the present invention. FIG. 3 is a top plan view of an exemplary embodiment of a display panel of an OLED display according to the present invention, and FIG. 4 is a cross-sectional view of the display panel of the OLED display shown in FIG. 3 taken along line IV-IV.

An exemplary embodiment of an OLED display according to the present invention includes a display panel 100, an encapsulation substrate which is an encapsulating member 200 for covering a display area ‘A’ of the display panel 100 (shown with phantom lines in FIG. 1), and a panel cover 300 for protecting and supporting the display panel 100. Also, when a circuit board 136 is disposed on the panel cover 300, the OLED display further includes a circuit board cover 400 for protecting the circuit board 136.

The display panel 100 includes the display area ‘A’ for displaying images and a peripheral area outside the display area ‘A’.

As shown in FIG. 2, a plurality of signal lines 121, 171 and 172 and a plurality of pixels connected to the signal lines 121, 171 and 172 and arranged approximately in a matrix are formed in the display area ‘A’.

The signal lines include a plurality of gate lines 121 for transmitting gate signals (or scanning signals), a plurality of data lines 171 for transmitting data signals, and a plurality of driving voltage lines 172 for transmitting a driving voltage. The gate lines 121 extend substantially in a row direction (e.g., horizontal direction as shown in FIG. 2) and are substantially parallel to each other, and the data lines 171 and the driving voltage lines 172 extend substantially in a column direction (e.g., vertical direction as shown in FIG. 2) and are substantially parallel to each other.

Each pixel PX includes a switching transistor Qs, a driving transistor Qd, a storage capacitor Cst and an organic light emitting diode (“OLED”) LD.

The switching transistor Qs has a control terminal connected to a gate line 121, an input terminal connected to a data line 171, and an output terminal connected to the driving transistor Qd. The switching transistor Qs transmits a data signal applied to the data line 171 to the driving transistor Qd in response to a scanning signal applied to the gate line 121.

The driving transistor Qd also includes a control terminal, an input terminal and an output terminal. The control terminal is connected to the output terminal of the switching transistor Qs, and the input terminal is connected to a driving voltage line 172. The output terminal is connected to the organic light emitting diode LD. The driving transistor Qd outputs an output current ILD having an intensity depending on a voltage applied between the control terminal and the output terminal of the driving transistor Qd.

The capacitor Cst is connected between the control terminal and the input terminal of the driving transistor Qd. The capacitor Cst stores a data signal applied to the control terminal of the driving transistor Qd and maintains the data signal even after the switching transistor Qs is turned off.

The organic light emitting diode LD includes an anode connected to the output terminal of the driving transistor Qd and a cathode connected to a common voltage Vss. The organic light emitting diode LD displays an image by emitting light having a varying intensity depending on the output current ILD of the driving transistor Qd.

In exemplary embodiments, the switching transistor Qs and the driving transistor Qd are n-channel field effect transistors (“FEATS”). However, in alternative exemplary embodiments, at least one of the switching transistor Qs and the driving transistor Qd may be a p-channel FET. Also, the connection relationship among the transistors Qs and Qd, capacitor Cst and the OLED LD may be modified.

Meanwhile, driving voltage pads 140 connected to ends of driving voltage lines 172 and common voltage pads 150 electrically connected to a common electrode 20 are formed in the peripheral area of the display area ‘A’ (see FIG. 1).

A plurality of driving voltage pads 140 are formed at predetermined intervals in the peripheral area on the opposite side of a data driver 132 with the display area ‘A’ interposed therebetween. Each driving voltage pad 140 applies a driving voltage of a predetermined level applied from an exterior voltage source input section 138 to a driving voltage line 172 through a metal wire 182 of a driving voltage cable 180.

A plurality of common voltage pads 150 are formed at predetermined intervals in the peripheral area on the opposite side of a gate driver 120 with the display area ‘A’ interposed therebetween. Each common voltage pad 150 applies a common voltage of a predetermined level applied from an exterior voltage source input section 138 to a common electrode 20 through a metal wire 182 of a common voltage cable 181.

Both of the voltage pads 140 and 150 may be made of the same wiring forming material as the gate metal material, or they may include a metal layer having conductivity as well as the wiring forming material, or the voltage pads 140 and 150 may be made of indium tin oxide (“ITO”) or indium zinc oxide (“IZO”).

The disposition of the voltage pads 140 and 150 is not limited to the above description, but it may be modified within the peripheral area, and the number of the voltage pads 140 and 150 may be increased or decreased considering the size of the display area and so forth.

Gate drivers 120 are formed in the opposite peripheral area of the peripheral area where the common voltage pads 150 are formed. Also, main drivers 130 for generating driving signals, including gate signals and data signals, are attached in the opposite peripheral area of the peripheral area where the driving voltage pads 140 are formed.

Each gate driver 120 transmits a gate signal received from a circuit board 136 of the main driver 130 to a gate line 121. Each gate driver 120 is mounted on the display panel 100 as a chip on glass (“COG”) type. In case that each gate driver 120 is mounted on the display panel 100 in a form of a chip, a gate on/off voltage outputted from a circuit board 136 can be supplied to a gate driver 120 through a fine wiring pattern (not shown) formed on the data driver 132 and the display panel 100. In other words, an exemplary embodiment of an OLED display according to the present invention does not include a separate circuit board connected to the gate driver 120.

Meanwhile, the gate driver 120 may include a shift register, not a chip, connected to a part of each gate line 121. The shift register consists of a plurality of transistors formed in the display panel 100 and is directly formed in the display panel 100 when the signal wiring is formed. Even when the gate driver 120 is formed by a shift register, a separate circuit board is not required because a gate on/off voltage applied to a gate line 121 and various display signals are directly transmitted to the shift register through electric wiring.

On the other hand, unlike the above, the gate driver 120 may receive the gate on/off voltage and various display signals through a separate circuit board (not shown) provided nearby.

A main driver 130 includes a data driver 132, a soft member 134 and a circuit board 136.

The data driver 132 formed on the soft member 134 applies a data signal received from the circuit board 136 to a data line 171.

The soft member 134 physically and electrically connects the circuit board 136 with the display panel 100. The soft member 134 may be attached to the display panel 100 and the circuit board 136 using an anisotropic conductive film (not shown), respectively. The soft member 134, which has pliability, can be easily transformed. Though it is not shown, fine wiring to electrically connect the data driver 132 to the display panel 100 and the circuit board 136 is formed in the soft member 134.

The circuit board 136, which is connected to a data driver 132 through a soft member 134, includes a voltage generator for generating various voltages supplied to the display area ‘A’ such as gate voltages and data voltages and a timing controller for outputting various display signals supplied to the gate drivers 120 and the data drivers 132.

According to another exemplary embodiment, a plurality of circuit boards 136, which are separated into parts for generating gray voltages and other parts for receiving display signals, may be provided. That is, a plurality of circuit boards 136 connected to the data drivers 132 may be connected to each other. The circuit board 136 is coupled with an exterior voltage source input section 138 for being supplied with an exterior voltage source and image signals.

In the present exemplary embodiment, the display panel 100 displays images by irradiating light which is emitted from an emission layer 10 to the rear. Accordingly, the circuit board 136 is folded to the opposite side of that where light is irradiated and images are displayed after the display panel 100 is completed. That is, the circuit board 136 connected to the data driver 132 is curved to the front side of the display panel 100 emitting light to the rear so that the circuit board 136 is disposed on the panel cover 300.

Gate lines 121 and data lines 171 in the display area ‘A’ extend to the peripheral area to be connected to the gate drivers 120 and the data drivers 132. Gate fan-out portions 123, where the gap of wiring of the extended gate lines 121 becomes narrower, and data fan-out portions 133, where the gap of wiring of the data lines 171 becomes narrower, are formed at the connections.

An encapsulation substrate which is an encapsulating member 200 is combined with the front side of the display panel 100 as best seen with reference to FIG. 4.

The encapsulation member 200 is arranged to face the display area ‘A’ of the display panel 100 and is then combined with the display panel 100. The thickness of the encapsulation member 200 is between about 0.5 millimeters (mm) to about 1.0 millimeter (mm), but is not limited thereto. The encapsulation member 200 prevents moisture and oxygen from permeating into the emission layer 10 formed in the display area ‘A’ to prevent degradation of the emission layer 10. A blocking film and/or a passivation film made of an organic material and/or an inorganic material may be formed between the common electrode 20 formed at the top of the display area ‘A’ of the display panel 100 and the encapsulation member 200. The blocking film and/or the passivation film, which is typically formed of a material which is hardened by heat or light, makes it easy for the display panel 100 and the encapsulation member 200 to combine with each other.

Along the side of the encapsulation member 200, driving voltage cables 180 are disposed in the left peripheral area and the lower peripheral area, and common voltage cables 181 are disposed in the right peripheral area.

The detailed combination of both of the voltage cables 180 and 181 and the voltage pads 140 and 150 corresponding to the respective voltage cables 180 and 181 will be described with an example of the driving voltage cable 180 and the driving voltage pad 140.

The driving voltage cable 180 includes a metal wire 182 and an insulating coat 184 covering the metal wire 182. The driving voltage cable 180 passing through the circuit board 136 is disposed in the left peripheral area and the lower peripheral area of the display panel 100 along the side of the encapsulation member 200, as illustrated in FIG. 3. One end of the driving voltage cable 180 is connected to the exterior voltage source input section 138, and the other end is connected to the rightmost driving voltage pad 140 among the plurality of driving voltage pads 140 formed in the lower peripheral area of the display panel 100.

The material of the metal wire 182 includes copper, aluminum, gold, silver, and alloys thereof, which have excellent electric conductivity. In exemplary embodiments, the diameter of the metal wire 182 is between about 0.05 millimeters (mm) to about 0.5 millimeters (mm) to decrease voltage drop phenomena due to an increase in the electrical resistance and considering that the thickness of the encapsulation member 200 may be between about 0.5 millimeters (mm) to about 1.0 millimeter (mm).

The insulating coat 184 is removed where the metal wire 182 is electrically connected with the driving voltage pad 140 through the flexible conductive film 165 and the anisotropic conductive film 160 by a conductive fixing member 190. However, the insulating coat 184 may be omitted over the entire peripheral area when the fine wiring formed in the peripheral area of the display panel 100 is sufficiently covered by an insulating material and insulation from the exterior by the passivation resin 195 is possible.

An anisotropic conductive film 160 is attached on the driving voltage pad 140. The anisotropic conductive film 160 improves the electric contact efficiency between the driving voltage pad 140 and the flexible conductive film 165 and the metal wire 182, and the anisotropic conductive film 160 softens any physical impact.

A portion of the flexible conductive film 165 is disposed between the anisotropic conductive film 160 and the metal wire 182, and the rest of the flexible conductive film 165 is curved upward to wrap around the conductive fixing member 190 which fixes the metal wire 182, as illustrated in FIG. 4.

The flexible conductive film 165 may include a thin metal film including copper, which has excellent electric conductivity, or may include the thin metal film and an insulating resin covering the thin metal film. In the case where the flexible conductive film 165 includes a thin metal film and an insulating resin, the insulating resin of the portion disposed between the anisotropic conductive film 160 and the metal wire 182 is removed to ensure smooth electric communication therebetween.

The conductive fixing member 190 fixes the exposed metal wire 182, with the insulating coat 184 removed therefrom, to the flexible conductive film 165, and electrically connects the metal wire 182 with the driving voltage pad 140. The conductive fixing member 190 may be a solder, such as lead or a known conductive resin, for example, which is hardened and has excellent electric conductivity.

The common voltage cable 181 also includes a metal wire 182 and insulating coat 184 covering the metal wire 182. The common voltage cable 181 passing through the circuit board 136 is disposed in the right peripheral area of the display panel 100 along the side of the encapsulation member 200. One end of the common voltage cable 181 is connected to the exterior voltage source input section 138, and the other end is connected to the lowest common voltage pad 150 among the plurality of common voltage pads 150 formed in the right peripheral area of the display panel 100, as illustrated in FIG. 3.

The material and diameter of the metal wire 182 of the common voltage cable 181 are the same as those of the metal wire 182 of the driving voltage cable 180.

The electric connection relationship between the common voltage cable 181 and the common voltage pad 150 is the same as that between the driving voltage cable 180 and the driving voltage pad 140, so the detailed description will be omitted.

A panel cover 300 is formed on the encapsulation substrate member 200, as illustrated in FIG. 1.

After the encapsulation member 200 is combined with the display panel 100, the circuit board 136 is connected, and the voltage cables 180 and 181 are disposed and fixed along the peripheral area, then the panel cover 300 is formed on the encapsulation member 200. The panel cover 300 wraps the display panel 100 to make transportation easy and protects the display panel 100 by supporting the display panel 100. The panel cover 300 is made of an insulating material so that it is electrically disconnected from a plurality of signal wires and the voltage pads 140 and 150 formed on the display panel 100. The panel cover 300 may include an insulating resin, which is lightweight and has good strength.

Unlike the present exemplary embodiment, the exterior voltage source input section 138 inputting a driving voltage and a common voltage corresponding to the voltage pads 140 and 150 may not be combined with the circuit board 136, but may be provided in the panel cover 300. In this case, the voltage cables 180 and 181 do not need to extend to the circuit board 136 in the peripheral area, but can be directly connected to the exterior voltage source input section 138 disposed in the panel cover 300 in the peripheral area.

The exterior voltage source input section 138 applies a driving voltage and a common voltage of a predetermined level generated by an exterior voltage source (not shown) to the driving voltage pad 140 and the common voltage pad 150 electrically connected with the flexible conductive film 165 and the anisotropic conductive film 160 through the corresponding voltage cables 180 and 181.

The circuit board cover 400 is disposed on the panel cover 300 to protect the circuit board 136 exposed to the outside. The circuit board cover 400 is generally formed of a thin plate made of an insulating resin material, and is fixed to the panel cover 300 by screws (not shown) or other suitable fastening means.

In the prior art, the common voltage and the driving voltage inputted from the exterior voltage source input section 138 via the circuit board 136 were transmitted to the respective voltage pads 140 and 150 through a plurality of flexible films and printed circuit boards (“PCBs”). Accordingly, the lateral side of the prior art display panel 100 had a complicated structure due to the plurality of PCBs, thus evoking problems of an OLED display having an increased thickness and making a modulation process difficult.

However, in an OLED display according to an exemplary embodiment of the present invention, voltage cables 180 and 181 having simple structures are substituted for a plurality of PCBs having a complicated structure, which input a driving voltage and a common voltage corresponding to the voltage pads 140 and 150 from the exterior voltage source input section 138. Therefore, the structure of the peripheral area of the display panel 100 can be simply arranged while a stable supply of a driving voltage and a common voltage is achieved, so that the OLED display can be slim and a modulation process becomes easy.

Hereinafter, an exemplary embodiment of a method of manufacturing the OLED display shown in FIG. 1 according to the present invention will be described in more detail with reference to FIGS. 1 to 8B.

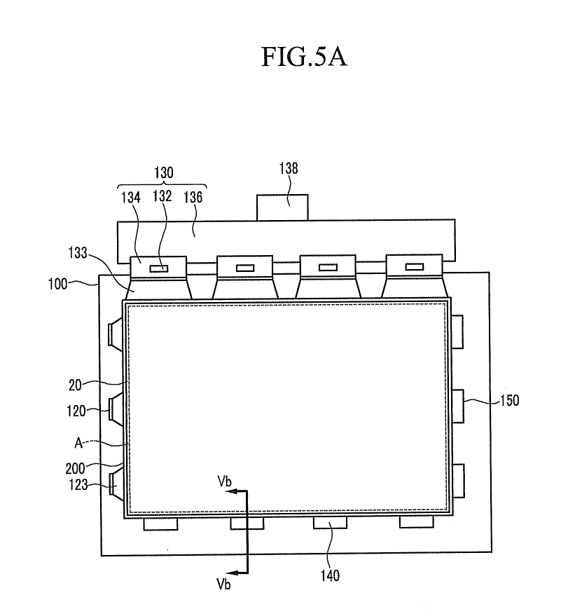

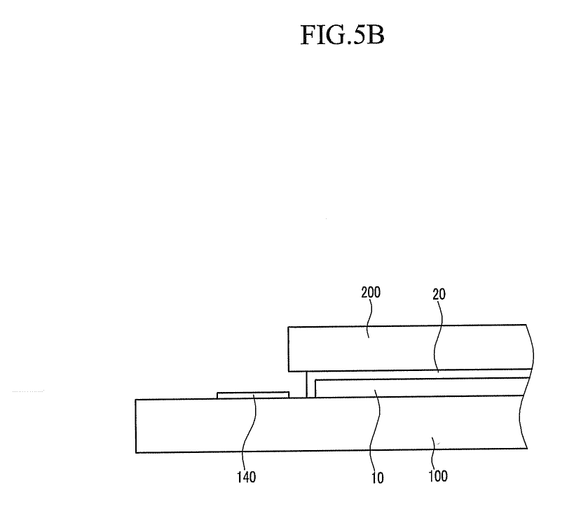

FIGS. 5A, 6A, 7A and 8A are top plan views of the display panel illustrating intermediate processing of an exemplary embodiment of a method of manufacturing the OLED display shown in FIG. 1 according to the present invention. FIGS. 5B, 6B, 7B and 8B are cross-sectional views of the display panel of the OLED display shown in FIGS. 5A, 6A, 7A and 8A taken along line Vb-Vb, VIb-VIb, VIIb-VIIb and VIIIb-VIIIb, respectively.

First, a display panel 100 having a display area ‘A’ and a non-display area provided along the circumference of the display area ‘A’ is provided.

TFTs Qs and Qd and an emission layer 10 are formed in the display area ‘A’ using a known method.

A plurality of driving voltage pads 140 for applying a driving voltage to driving voltage lines 172 formed in the display area ‘A’ are formed in the lower peripheral area of the display area ‘A’, as illustrated in FIG. 5A, using a known method. A plurality of common voltage pads 150 for applying a common voltage to a common electrode 20 formed in the display area ‘A’ are formed in the right peripheral area of the display area ‘A’ using a known method, as illustrated in FIG. 5A.

In the mean time, in the process of providing the display panel 100, gate drivers 120 are formed in the left peripheral area of the display area ‘A’ using a known method, and main drivers 130 including a data driver 132 are also formed in the upper peripheral area, as illustrated in FIG. 5A.

Next, an encapsulation substrate which is an encapsulating member 200 covering the display area ‘A’ is formed on the display panel 100, thereby providing a display panel 100 attached with an encapsulating member 200 as shown in FIGS. 5A and 5B.

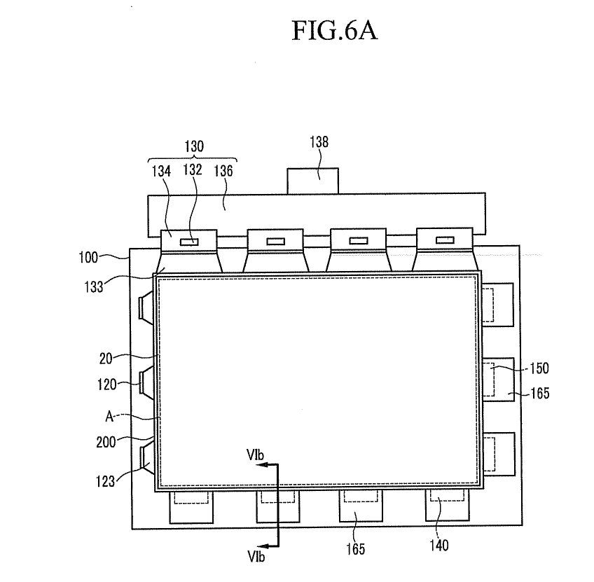

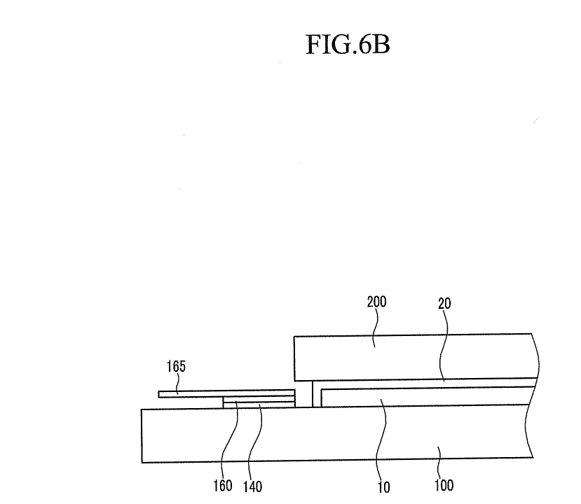

Then, as shown in FIGS. 6A and 6B, a portion of a flexible conductive film 165 is attached using an anisotropic conductive film 160 on both of the voltage pads 140 and 150, respectively.

The coupling process of the respective voltage pads 140 and 150 and the flexible conductive film 165 is performed by sequentially depositing an anisotropic conductive film 160 and a portion of a flexible conductive film 165 on the respective voltage pads 140 and 150 and by a pressing process applying a press on the flexible conductive film 165. In this way, each of the voltage pads 140 and 150 and the flexible conductive film 165 are physically and electrically connected to each other via the anisotropic conductive film 160.

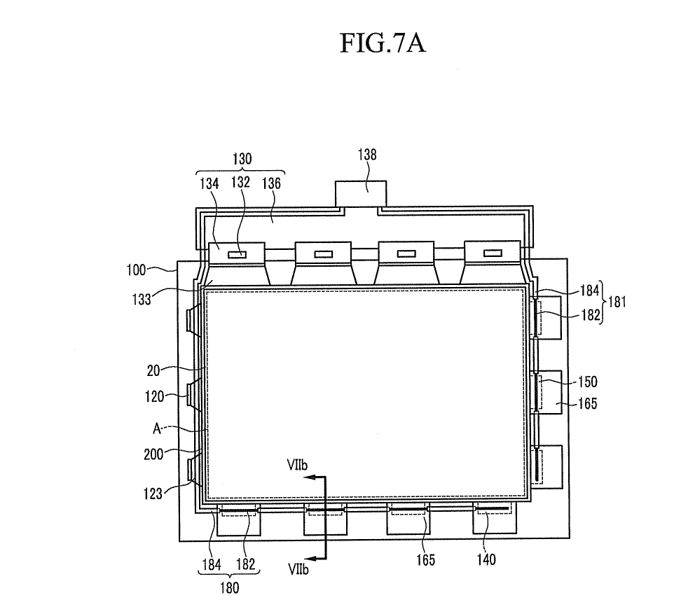

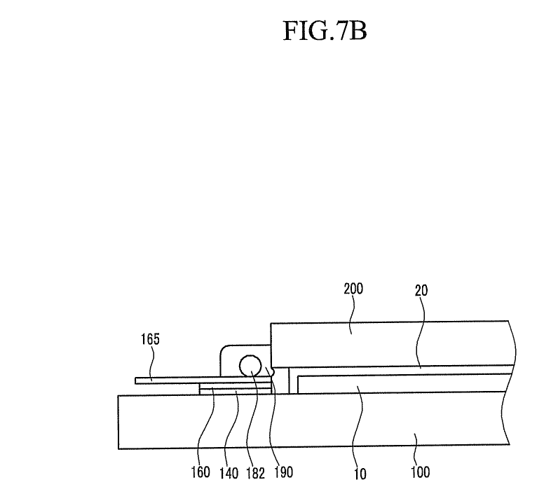

Next, as shown in FIGS. 7A and 7B, both voltage cables 180 and 181, one end of each of which is connected to an exterior voltage source input section 138, are disposed along the peripheral area of the display panel 100.

The driving voltage cable 180 starts from the exterior voltage source input section 138 to pass through a circuit board 136 and a plurality of gate fan-out portions 123 formed in the left peripheral area along the lateral side of the encapsulating member 200 and then is disposed on a plurality of driving voltage pads 140 formed in the lower peripheral area, as illustrated in FIG. 7A. Here, the insulating coat 184 of the driving voltage cable 180 disposed on each driving voltage pad 140 is removed to expose the metal wire 182.

Meanwhile, the common voltage cable 181 starts from the exterior voltage source input section 138 to pass through the circuit board 136 and is disposed on a plurality of common voltage pads 150 formed in the right peripheral area along the lateral side of the encapsulating member 200, as illustrated in FIG. 7A. Here, the insulating coat 184 of the common voltage cable 181 disposed on each common voltage pad 150 is also removed to expose the metal wire 182.

Then, the exposed metal wire 182 of the voltage cable 180 and 181 corresponding to the flexible conductive film 165 attached on each of the voltage pads 140 and 150 is fixed through soldering using a conductive fixing member 190 including lead, for example, but is not limited thereto. That is, each metal wire 182 is fixed on each of the voltage pads 140 and 150 via an anisotropic conductive film 160 and a flexible conductive film 165 by soldering. In FIG. 7A, the conductive fixing member 190 is not shown for convenience.

Meanwhile, in a case of fixing each metal wire 182 on the corresponding voltage pad 140 and 150 using a conductive fixing member 190 including a hardened conductive resin, a process of hardening the conductive resin composition using a heat or ultraviolet hardening method is performed after coating a conductive resin composition in a liquid or gel state on each exposed metal wire 182 on the voltage pads 140 and 150.

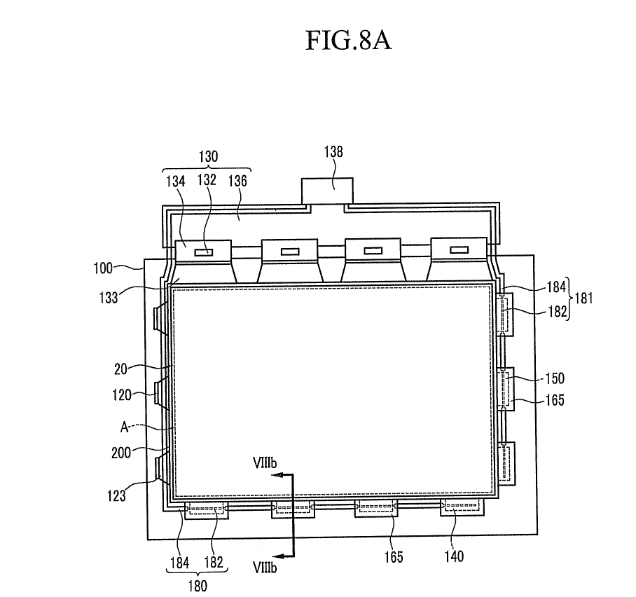

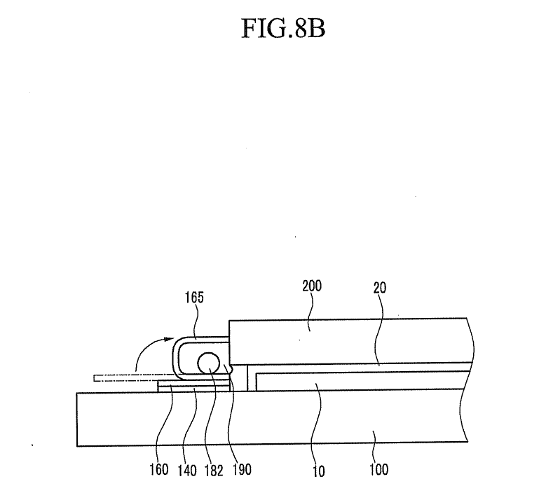

Next, as shown in FIGS. 8A and 8B, the flexible conductive film 165 not attached to the anisotropic conductive film 160 and the conductive fixing member 190 is curved upward to wrap around the metal wire 182 and the conductive fixing member 190.

Next, as shown in FIGS. 3 and 4, an insulating resin composition in a liquid or gel state, including a material such as silicon for fixing and protecting the conductive fixing member 190 and the voltage cables 180 and 181, is coated along the peripheral area and hardened to form an insulating resin in the peripheral area.

Then, a panel cover 300 is coupled with the encapsulating member 200, and a soft member 134 is curved so that the circuit board 136 is disposed on the panel cover 300. A circuit board cover 400 is then coupled with the panel cover 300, thereby completing an exemplary embodiment of an OLED display according to the present invention.

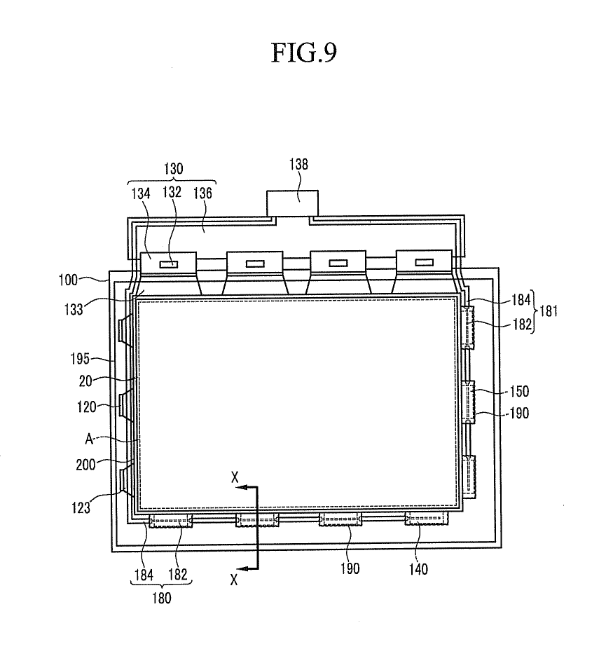

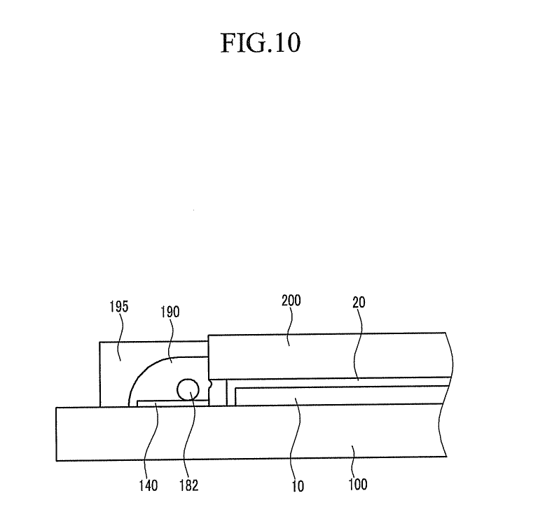

Hereinafter, an OLED display according to another exemplary embodiment of the present invention which is shown in FIGS. 9 and 10 will be described in more detail focusing on differences with the exemplary embodiment of the OLED display according to the present invention shown in FIG. 1.

FIG. 9 is a top plan view of another exemplary embodiment of a display panel of an OLED display according to the present invention, and FIG. 10 is a cross-sectional view of the display panel of the OLED display shown in FIG. 9 taken along line X-X.

The OLED display according to another exemplary embodiment of the present invention shown in FIG. 9 and FIG. 10 is the same as the exemplary embodiment of the OLED display according to the present invention shown in FIG. 1 except that the anisotropic conductive film 160 and the flexible conductive film 165 are not formed between the respective voltage pads 140 and 150 and the metal wire 182.

Each metal wire 182 can be physically and electrically connected with the corresponding voltage pad 140 and 150 via the conductive fixing member 190 not being isolated from the corresponding voltage pad 140 and 150. Therefore, the resistance is less compared to the case of using an anisotropic conductive film 160 and a flexible conductive film 165 thus allowing voltage drop phenomena to be improved, and accordingly, improving the electric performance of an OLED display.

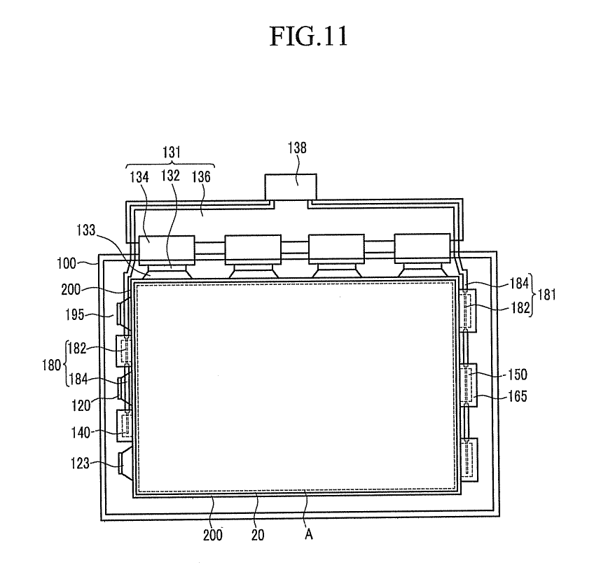

Hereinafter, an OLED display according to yet another exemplary embodiment of the present invention which is shown in FIG. 11 will be described in more detail focusing on differences with the exemplary embodiment of the OLED display according to the present invention shown in FIG. 1.

FIG. 11 is a top plan view of yet another exemplary embodiment of a display panel of an OLED display according to the present invention.

In the OLED display according to another exemplary embodiment of the present invention shown in FIG. 11, the data driver 132 of the main driver 131 is not attached to the soft member 134, but is attached to the peripheral area of the display panel 100 as a COG type. Also, the OLED display according to yet another exemplary embodiment of the present invention shown in FIG. 11 is the same as the exemplary embodiment of the OLED display according to the present invention shown in FIG. 1 except that the driving voltage pads 140 are formed between the gate drivers 120 disposed in the left peripheral area not the lower peripheral area. Alternatively, unlike the present exemplary embodiment of FIG. 11, the driving voltage pads 140 may be formed between the data drivers 132 disposed in the upper peripheral area.

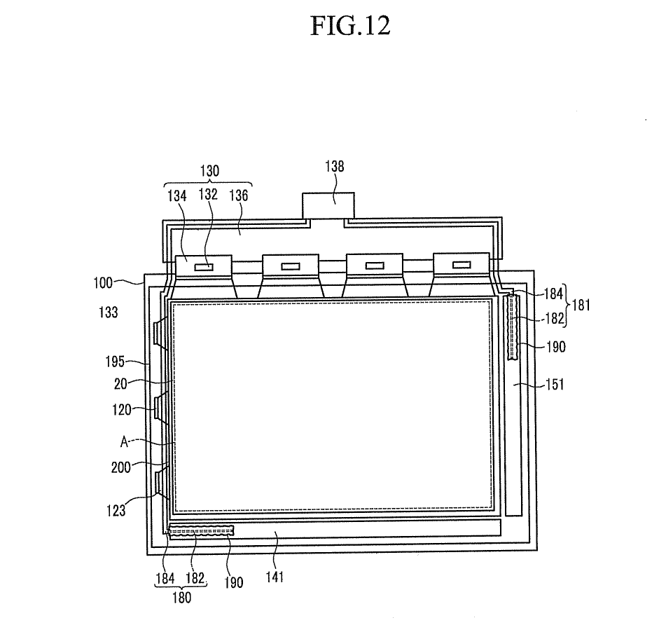

Hereinafter, still another exemplary embodiment of an OLED display according to the present invention, which is shown in FIG. 12, will be described in more detail focusing on differences with the exemplary embodiment of the OLED display according to the present invention shown in FIG. 1.

FIG. 12 is a top plan view of still another exemplary embodiment of a display panel of an OLED display according to the present invention.

In the OLED display according to still another exemplary embodiment of the present invention shown in FIG. 12, driving voltage pads 141 and common voltage pads 151 are not each formed as a plurality in number and disposed at predetermined intervals in the peripheral area, but each one of the driving voltage pad 141 and the common voltage pad 151, which is respectively bar-shaped, is formed along the lower and the right peripheral areas, respectively. Also, the metal wire 182 of each voltage cable 180 and 181 is fixed and connected to the respective voltage pads 141 and 151 through a conductive fixing member 190, including soldered lead, for example, applies a driving voltage and a common voltage to the corresponding voltage pad 141 and 151, respectively.

The OLED display according to alternative exemplary embodiments of the present invention respectively shown in FIGS. 10 to 12 also provide the same effect as the exemplary embodiment of the OLED display according to the present invention shown in FIG. 1.

Though it was described that both a driving voltage and a common voltage are applied using corresponding driving voltage cables 180 and common voltage cables 182 , respectively, in the above exemplary embodiments, only one of the driving voltage and the common voltage may be applied using a corresponding voltage cable 180 and 181 and the other may be applied using a known FPC.

As described above, according to the present invention, an OLED display having a simple structure to be slim and having the advantage of easy modulation and a manufacturing method thereof are provided.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. An organic light emitting diode display comprising:
a display panel including a display area in which a plurality of thin film transistors and an emission layer are formed and a peripheral area disposed along a circumference of the display area;
at least one driver provided in the peripheral area, the driver applying a display signal including a gate signal and a data signal to a thin film transistor of the plurality of thin film transistors;
a voltage pad formed in the peripheral area, the voltage pad applies at least one of a driving voltage and a common voltage to the display area;
an exterior voltage source input section which applies at least one of the driving voltage and the common voltage to the voltage pad;
a metal wire connecting the exterior voltage source input section and the voltage pad; and
a conductive fixing member for fixing the metal wire to the voltage pad.

2. The organic light emitting diode display of claim 1, wherein a diameter of the metal wire is between about 0.05 millimeters to about 0.5 millimeters.

3. The organic light emitting diode display of claim 1, further comprising an insulating coat covering the metal wire,
wherein the insulating coat is removed from a fixed part of the metal wire corresponding to the conductive fixing member.

4. The organic light emitting diode display of claim 1, wherein the conductive fixing member includes lead formed by soldering or a hardened conductive resin.

5. The organic light emitting diode display of claim 1, further comprising:
an anisotropic conductive film formed on the voltage pad; and
a flexible conductive film formed on the anisotropic conductive film and wrapped around the metal wire and the conductive fixing member.

6. The organic light emitting diode display of claim 1, further comprising an insulating resin formed along the peripheral area and covering the conductive fixing member and the metal wire.

7. The organic light emitting diode display of claim 1, further comprising an encapsulating member covering the display area of the display panel.

8. The organic light emitting diode display of claim 7, wherein the metal wire is formed along a lateral side of the encapsulating member.

9. The organic light emitting diode display of claim 1, wherein the driver comprises:
a circuit board which generates the display signal;
a soft member connecting the display panel and the circuit board; and
a data driver which applies the data signal received from the circuit board to the thin film transistor.

10. The organic light emitting diode display of claim 9, wherein the driver further comprises at least one gate driver which applies the gate signal to the thin film transistor.

11. The organic light emitting diode display of claim 9, wherein the exterior voltage source input section is connected to the circuit board.

12. The organic light emitting diode display of claim 10, wherein the voltage pad is at least one of a driving voltage pad and a common voltage pad formed in an opposite peripheral area of a peripheral area in which the gate driver or the data driver is formed with the display area interposed therebetween.

13. The organic light emitting diode display of claim 10, wherein the gate driver or the data driver is plural in number, and
the voltage pad is at least one of a driving voltage pad and a common voltage pad formed between a plurality of the gate drivers or the data drivers.

14. A method of manufacturing an organic light emitting diode display, the method comprising:
providing a display panel including a display area in which a thin film transistor and an emission layer are formed, and a peripheral area in which a voltage pad which applies at least one of a driving voltage and a common voltage to the display area is formed, the peripheral area being formed along a circumference of the display area;
disposing a metal wire in the peripheral area, one end of the metal wire is connected to an exterior voltage source input section;
fixing the metal wire on the voltage pad using a conductive fixing member; and
forming an insulating resin covering the conductive fixing member and the metal wire along the peripheral area.

15. The method of claim 14, further comprising forming an encapsulating member covering the display area on the display panel after the providing of the display panel and before the disposing of the metal wire in the peripheral area.

16. The method of claim 14, further comprising attaching a portion of a flexible conductive film on the voltage pad using an anisotropic conductive film after the providing of the display panel and before the disposing of the metal wire in the peripheral area.

17. The method of claim 16, further comprising wrapping the metal wire and the conductive fixing member by curving the flexible conductive film after the fixing of the metal wire on the voltage pad using the conductive fixing member.

18. The method of claim 14, wherein the conductive fixing member includes lead, and
the fixing of the metal wire on the voltage pad is performed by soldering of the lead.

19. The method of claim 14, wherein the conductive fixing member includes a hardened conductive resin, and
the fixing of the metal wire on the voltage pad comprises:
coating a conductive resin composition in a liquid or gel state including a hardener on the metal wire disposed on the voltage pad; and
hardening the conductive resin composition.

20. The method of claim 14, wherein the providing the display panel further comprises forming at least one driver in the peripheral area, the driver applies a display signal including a gate signal and a data signal to the thin film transistor.
